(19) United States
(12) Patent Application Publication
(10) Pub. No.: US 2016/0253608 A1
(43) Pub. Date: Sep. 1, 2016

(54) System and Method for Assessing Risk and Marketing Potential Using Industry-Specific Operations Management Transaction Data

(71) Applicant: Joseph DiMartino, Gainesville, FL (US)

(72) Inventor: Joseph DiMartino, Gainesville, FL (US)

(21) Appl. No.: 15/045,337

(22) Filed: Feb. 17, 2016

Related U.S. Application Data
(60) Provisional application No. 62/121,407, filed on Feb. 26, 2015.

(51) Int. Cl. G06Q 10/06; G06Q 40/02; G06Q 40/08; G06Q 30/02

(52) U.S. Cl. CPC G06Q 10/0635; G06Q 30/0206; G06Q 30/0202; G06Q 10/06393; G06Q 40/025; G06Q 40/08

(57) ABSTRACT

The present invention relates generally to the analysis and use of operations management, facility management, and/or security system transaction data in the field of computerized systems and methods for processing data related to insurance and finance to determine future risk associated with a specific entity's predicted property and casualty losses or credit losses. More specifically, the invention relates to a system and method for incorporating transaction oriented data from operations management, facility management, and/or security systems into insurance and finance risk assessment underwriting, pricing/quoting, and retention management.

### CROSS-REFERENCE TO RELATED APPLICATIONS

This application makes reference to U.S. Prov. App. No. 62/121407 filed Feb. 26, 2015 which is incorporated by reference in its entirety.

### FIELD OF THE INVENTION

The present invention relates generally to the analysis and use of operations management, facility management, and/or security system transaction data in the field of computerized systems and methods for processing data related to insurance and finance to determine future risk associated with a specific entity's predicted property and casualty losses or credit losses. More specifically, the invention relates to a system and method for incorporating transaction oriented data from operations management, facility management, and/or security systems into insurance and finance risk assessment underwriting, pricing/quoting, and retention management.

### GLOSSARY

In this disclosure, the following terms are understood to have the following meanings: 1) Underwriting—Defining an entity's eligibility for a particular insurance or loan product and the terms associated with that eligibility; 2) Pricing/quoting—Pricing defines the insurance premium or loan interest rate for the product while quoting involves utilizing data extracted from operations management systems to generate a price quote for the entity; 3) Retention management—Includes various account management treatments such as: a) Renewal underwriting (account non-renewal or change in terms); b) Account monitoring (account cancellation, enterprise risk management acceptability monitoring); c) Premium audit; d) Loss control; e) Coverage/product upsell; f) Validation (underwriting data validation, claim eligibility validation); g) Referral product marketing opportunities (referrals to other firms for potential product needs determined by analysis of operations transaction data); h) Benchmarking (comparing an individual entity's operational transactions to a group of unaffiliated entities, typically operating within the same industry, for the purpose of understanding how the individual entity's operational experience differs or conforms to others and to define actionable insights that may impact future operational results); i) Monitoring (the process of maintaining communication with a device within an operations management system or software or directly though ongoing communication with an operations management system or software that provides an ongoing [or constant] assessment of performance, particularly relative to a predefined threshold or specific parameters); and, 4) Home monitoring system—Including any software or system that monitors or controls a home environment or any system or software that monitors factors that influence a home environment (including damage to), such as: Entry gates; Stove; Dryer; Dishwasher; Washing machine; Refrigerator; Doors; Hot water heater; Heating; Cooling; Roof; Sinks; Water pipes; Toilets, Showers/baths; Garage doors; Sump pump; Windows; Gas lines; Electric lines; Air humidity; Smoke; Carbon monoxide; Wind speed; Rain; Sleet/hail; Snow; Movement of earth; Fire; Lightning; Sound; Moisture; and, similar home-based devices and influences. Monitoring may include the use of sensors.

### BACKGROUND OF THE INVENTION

The underwriting and pricing of insurance and loans involves the application of underwriter judgment and the application of established statistical methods to the analysis of historical loss performance, risk characteristics of the entity, and exposure detail. Currently the realm of possible data sources considered in when assessing risk includes credit agency rating data, business loss history, geographic data (weather, seismic, fire protection class, etc.), general business attributes (years in business, class of business, sales, etc.), business property attributes (the type of construction, square footage, whether a security system is installed, etc.) and, of course, the details of the requested coverage/loan.

Today, most businesses and a number of many individuals have installed some form of operations management, facility management, and/or security system in their facilities and/or homes. Risk-related and marketing transaction data resides in these systems but it cannot be considered in the underwriting process because the data is simply unavailable for analysis. As an example, consider a retail product fulfillment operation encompassing a warehouse and showroom. Ordinarily, an insurance policy would be underwritten considering traditional factors such as the size and location of the warehouse including its proximity to a fire station, the character and nature of the fire suppression and security systems it incorporates, the general characteristics of the goods sold and shipped to and from the warehouse, and numerous other factors determined when the policy is underwritten.

In reality there are myriad other factors that would affect an underwriting decision if those factors were known. For example, how many customers enter the showroom every day and how much retail activity do they generate? What kinds of goods do they buy? Are any potentially hazardous? Does the facility sell alcohol? If so, how much? This type of data resides in the client's operations management system. Are vital components of the physical plant quickly repaired or repaired at all? Has a vendor of lead-acid batteries, industrial chemicals, and compressed gas cylinders recently leased space in the warehouse? Is the fire suppression system in one part of the warehouse temporarily out-of-service? This type of data resides in the client's facility management system. Were employees screened as they entered/exited the facility for loss protection purposes? Did management ensure that the security system was actually armed after working hours? Is the night security staff actually making its rounds? This type of data resides in the client's security system.

As importantly, this information varies over time. Vendors come and go, the types and quantities of goods received, sold, and shipped changes, internal management practices and efficiencies change, and so on. The data resident in the client's operations management, facility management, and/or security systems show a dynamically changing measure of risk that would have great value if incorporated into the process of insurance and finance product underwriting, pricing/quoting and retention management. Further, because of the disparate nature of this data across business classes (e.g. dentists, restaurants, hotels, etc.) it has not been possible to incorporate this level of detail into the risk and marketing assessment of insurance and loans.

What is needed then is a system and method for extracting, aggregating, normalizing, and incorporating this operations management, facility management, and/or security system transaction data into risk assessment and marketing data suitable for consumption by insurance and finance underwriting systems.

### SUMMARY OF THE INVENTION

According to one embodiment of the present invention, a system and method for advanced underwriting and pricing using operations management, facility management, and/or security system transaction data is disclosed.

According to another embodiment, the invention relates to a system that assists in the underwriting of insurance policies or loans using transaction data extracted from an arbitrarily large sampling of related entity's operations management, facility management, and/or security system(s) comprising: 1) A data collection facility capable of extracting transaction data from the identified entity's operations management, facility management, and/or security system relating to internal conditions and practices indicative of a level of risk or marketing potential wherein the data collection facility uses a pre-created, industry-specific data extraction schema to extract the necessary data; 2) A data normalizing facility to normalize the extracted data into a standard form wherein the normalizing facility uses a pre-created, industry-specific data normalization schema; 3) An aggregating facility capable of aggregating the standardized data from a multiplicity of similarly situated entities; and, 4) A risk factor calculating facility capable of cross correlating historical loss data associated with the multiplicity of similarly situated entities with the aggregated standardized data from the multiplicity of similarly situated entities to create risk weighting factors correlating the aggregated standardized data with losses.

According to another embodiment, the invention relates to a system that assists in the underwriting of insurance policies or loans using data extracted from a single unrated/rerated client's operations management, facility management, and/or security system transaction data comprising: 1) A data collection facility capable of extracting transaction data from an unrated/rerated entity's operations management, facility management, and/or security system transaction data relating to internal practices indicative of a level of risk or marketing potential wherein the data collection facility uses a pre-created, industry-specific data extraction schema to extract the necessary data; 2) A data normalizing facility to normalize the extracted data into a standard form wherein the normalizing facility uses a pre-created, industry-specific data normalization schema; 3) A risk rating facility capable of applying risk weighting factors to each of the normalized operational data to create risk-related ratings wherein the risk weighting factors are determined a priori; and, 4) A calculating facility capable of aggregating these risk related ratings to create an underwriting decision, score, or risk/marketing summary for transmission to stakeholders in the final underwriting process.

According to another embodiment, the invention relates to a method of using the systems described at [¶0010] and [¶0011] to assist in the underwriting of insurance policies or loans using data extracted from operations management, facility management, and/or security system transaction data comprising the steps of: 1) Identifying a representative sample of similarly situated entities operating with at least a multiple of like operational parameters (e.g. NAICS/SIC code, size, revenues, location, etc.); 2) Collecting operations management, facility management, and/or security system transaction data from each of the entities for multiple arbitrary time periods within an historical time period; 3) Normalizing the extracted data into a standard form wherein the normalizing facility uses a pre-created, industry-specific data normalization schema; 4) Aggregating this normalized operations management, facility management, and/or security system transaction data into a historical data set representing normalized operational events of all such similarly situated entities over the historical period; 5) Obtaining credit and/or property and casualty loss data, exposure data, and interest rate and/or premium data associated with the losses for all the entities for the historical time period; 6) Creating a risk relationship between the loss data and the historical data set representing operational events of all similarly situated entities over the historical period; 7) Collecting operations management, facility management, and/or security system transaction data from an unrated/rerated client; 8) Normalizing the extracted data; and, 9) Applying the risk relationship calculated a priori to the unrated/rerated client's operations and facility management and security system transaction data to create an underwriting decision, score, or risk/marketing summary for the client to be rated/rerated.

The main benefit of these and other embodiments of the present invention is an improved and computerized insurance and finance underwriting, pricing/quoting, and retention management system providing improved pricing specificity.

This benefits insurance and finance companies because such entities evaluate multiple sources of information when assessing risk, and a more accurate evaluation of a client's internal risk profile improves profitability through more accurate underwriting and/or pricing decisions. Also, it allows insurance and finance companies to develop products better tailored to specific risk profiles. By the same token, the present invention benefits clients of insurance and finance companies because such entities would have access to more fulsome evaluations of their internal risk profile, the insurance/lending costs associated therewith, as well as allowing them to develop strategies to mitigate those risks.

### BRIEF DESCRIPTION OF THE DRAWINGS

FIG. 1 shows a block diagram of one embodiment of the present invention.

FIG. 2 shows a block diagram of another embodiment of the present invention.

FIG. 3 is a flow diagram showing how one embodiment of the present invention creates risk weighting factors correlating aggregated standardized operations, facility management, and/or security system transaction data with losses.

FIG. 4 is a flow diagram showing how one embodiment of the present invention calculates and communicates an underwriting decision, score, or risk/marketing summary to stakeholders in the underwriting process.

FIG. 5 is a flow diagram illustrating the method whereby an embodiment of the present invention creates risk weighting factors correlating aggregated standardized operations management, facility management, and/or security system transaction data with losses and subsequently calculates and communicates an underwriting decision, score, or risk/marketing summary to stakeholders in the underwriting process.

### DETAILED DESCRIPTION OF THE EMBODIMENTS

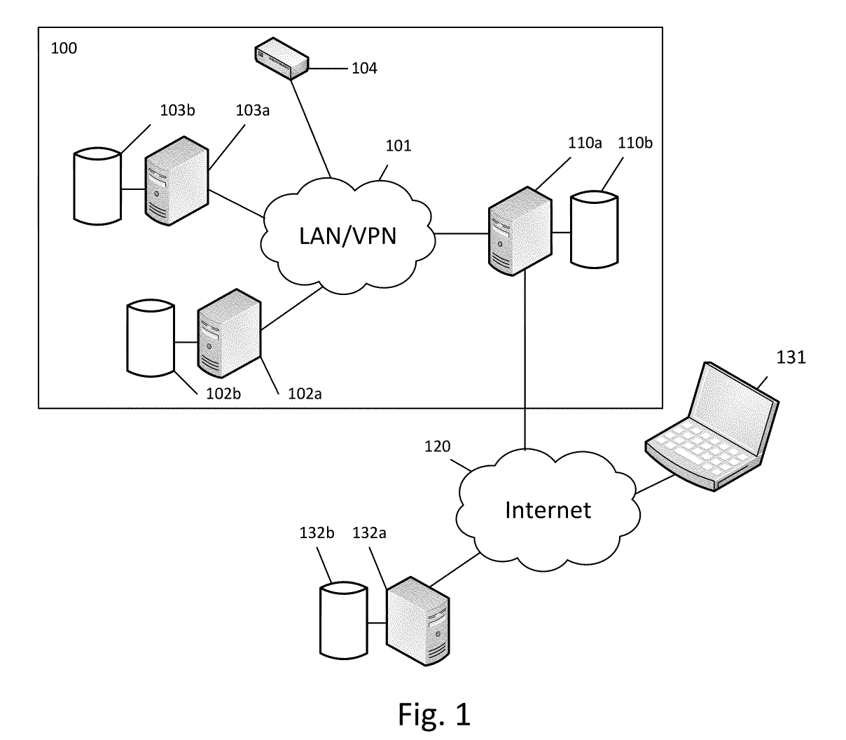

Referring now to FIG. 1 a block diagram of one embodiment of the present invention is shown. In this embodiment, client's premises IT infrastructure 100 comprises operations management server 102a with associated operations management database 102b, facilities management server 103a with associated facilities management database 103b, and security system 104 all of which are connected to client's internal LAN/VPN 101. In this embodiment, client's IT infrastructure also comprises data collection server 110a and data collection database 110b also connected to client's internal LAN/VPN 101. In this embodiment, a unitary data collection server 110a and data collection database 110b is provided for each client. Data collection server 110a is accessible outside of client's IT infrastructure 100 by means of a network such as the Internet 120.

Operations management server 102a and associated operations management database 102b collect and store, respectively, the client's operational data. Operational data is defined as data relating to the functions of a firm or organization relating to development, production, manufacturing, sales, marketing, human resource management, payroll, accounting, legal management, billing, purchasing, and the like systems/software including particularly, the individual transactions associated with each of these functions. Such information may also be referred to as operational transaction data.

Facilities management server 103a and associated facilities management database 103b collect and store, respectively, the client's facilities related data. Facilities related data is defined as data relating to buildings and the physical systems that comprise them and involves the gathering and processing or information that is required for maintaining acceptable indoor comfort and safety levels, including particularly, the individual transactions associated with each of these functions. Such information may also be referred to as facilities transaction data.

Security system 104 collects and stores, the client's security related data. Security related data is defined as data relating to the protection status of buildings, the systems that comprise them and the goods and people that are located therein. Such information may also be referred to as security data.

It will be readily apparent to those having skill in the art that not all of these systems and types of data need be present (or managed) in any one client's IT infrastructure 100. For example, one client may possess and manage all three types of data, where a second client has only operational transaction data and security data, a third client only has facilities transaction data and security data recorded in its home-based whole-house management system, and a fourth client has only security data recorded in its home security system.

Data collection server 110a and data collection database 110b also reside in client's IT infrastructure 100. Data collection server 110a accesses operational transaction data in operations management database 102b by means of operations management server 102a, facilities transaction data in facilities management database 103b by means of facilities management server 103a, and security data by means of security system 104.

Data collection server 110a accesses operational transaction data in operations management database 102b, facilities transaction data in facilities management database 103b, and security data relating to internal conditions and practices indicative of a level of risk/marketing potential wherein data collection server 110a uses a pre-created, industry-specific data extraction schema to extract the necessary data from the appropriate system. In many cases the pre-created, industry-specific data extraction schema comprises custom program code running on data collection server 110a capable of extracting the necessary data from a particular system. In other cases the pre-created, industry-specific data extraction schema comprises custom program code running on operations management server 102a and/or facilities management server 103a capable of extracting the necessary data from a particular system. In other cases the pre-created, industry-specific data extraction schema comprises a report template or report program running on operations management server 102a, facilities management server 103a, and/or security system 104 capable of extracting the necessary data from a particular system.

After collecting operational transaction data, facilities transaction data, and security data, data collection server 110a normalizes, or formats, the collected data into a lexically consistent form capable of being consumed by remaining downstream processes. In many cases the pre-created, industry-specific data extraction schema comprises custom program code running on data collection server 110a capable of normalizing, or formatting, the collected data into a standardized form.

In this embodiment, data aggregation server 132a and associated data aggregation database 132b lies outside of the client's IT infrastructure and operates by collecting normalized data from at least one data collection server 110a by means of a network such as the Internet 120. Ordinarily, data aggregation server 132a collects data from a multiplicity of data collection servers 110a each of which is installed in a different client's IT infrastructure 100 and each of which collects and normalizes a particular client's operational transaction data, facilities transaction data, and/or security data. Data aggregation server 132a stores this data with metadata identifying the client, the type of client (e.g. NAICS/SIC code (if any)), specifications regarding the client's IT environment, and any other pertinent identifying information in data aggregation database 132b.

Data aggregation server 132a also provides a risk factor calculating facility capable of: 1) Retrieving historical loss data associated with the multiplicity of different clients whose normalized operational transaction data, facilities transaction data, and/or security data has been collected; and, 2) Cross correlating this historical loss data with the aggregated normalized operational transaction data, facilities transaction data, and/or security data collected to create risk weighting factors correlating the aggregated standardized data with losses. For example, if the operational transaction data of a particular warehouse operator (NAICS code 493110—General warehousing and storage) shows that the operator routinely stored liquid propane gas on its premises and the warehouse operator suffered a pertinent loss (e.g. fire) then a risk weighting factor correlating the storage of liquid propane gas by clients classified in NAICS code 493110 with increased risk will be created and stored.

Finally, data aggregation server 132a provides a web interface whereby stakeholders in the insurance/finance underwriting process and their potential clients may access decision reports and risk rating scores derived from the stored weighting factors by means of computer 131 to better assess the risks and costs involved in underwriting and/or purchasing particular finance and/or insurance products.

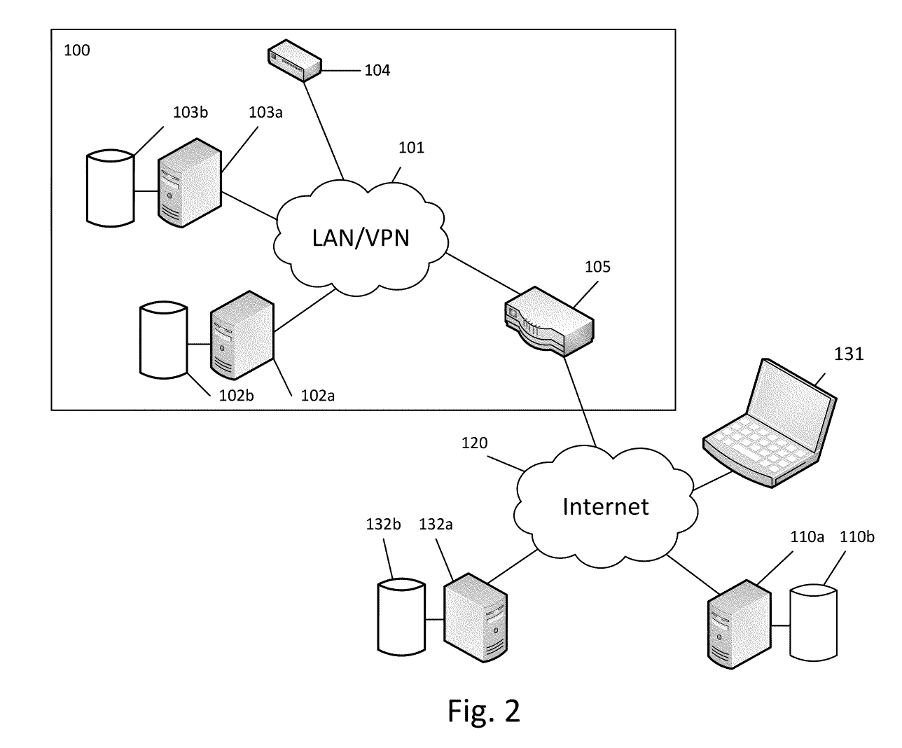

Turning now to FIG. 2 a block diagram of one embodiment of the present invention is shown. This embodiment comprises the same systems and interconnections as described above, except that this embodiment removes data collection server 110a and data collection database 110b from the client's IT infrastructure 100 and places it external to IT infrastructure 100. In this embodiment, data collection server 110a and data collection database 110b access the client's IT infrastructure 100 by means of a network, such as the Internet 120. By this means, one data collection server 110a collects operational transaction data, facilities transaction data, and/or security data from a multiplicity of operations management servers 102a, facilities management servers 103a, and security systems 104 each of which may be connected to a different client's internal LAN/VPN 101. This embodiment provides the economic advantage of utilizing one data collection server 110a to collect data from a multiplicity of client's.

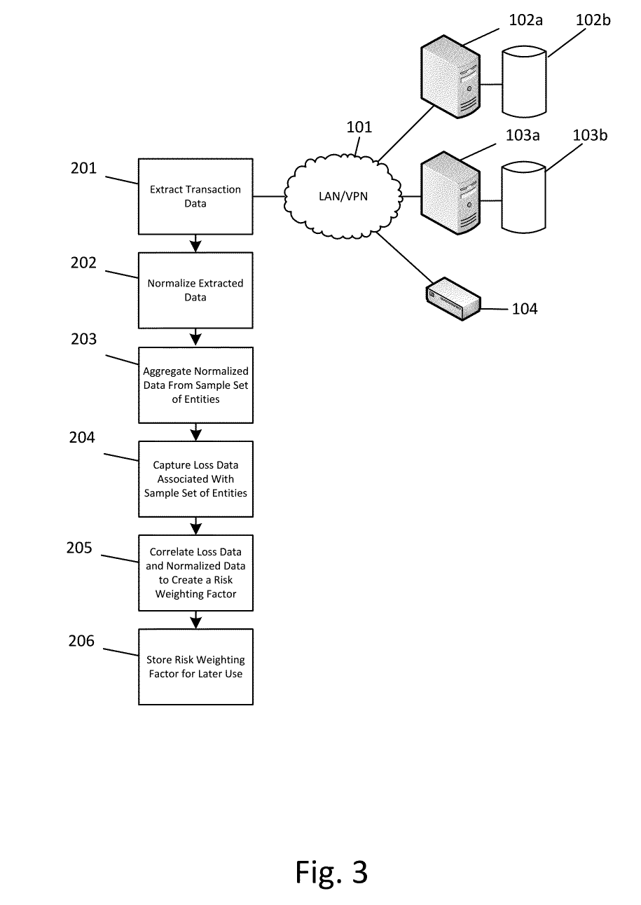

Referring now to FIGS. 1 and 3 a flow diagram showing how one embodiment of the present invention creates risk weighting factors correlating aggregated standardized operations and facility management and/or security system transaction data with losses is disclosed. First, data collection server 110a accesses operational transaction data in operations management database 102b by means of operations management server 102a, facilities transaction data in facilities management database 103b by means of facilities management server 103a, and/or security data by means of security system 104 wherein data collection server 110a uses a pre-created, industry-specific data extraction schema to extract the necessary data from the appropriate system (201). Next, after collecting operational transaction data, facilities transaction data, and/or security data, data collection server 110a uses a pre-created, industry-specific data normalization schema to normalize, or format, the collected data into a lexically consistent form capable of being consumed by remaining downstream processes (202). Next, at some arbitrary time later (after an arbitrarily sized set of normalized operational transaction data, facilities transaction data, and/or security data has been collected by at least one (but ordinarily more) data collection servers 110a) data aggregation server 132a collects data from the at least one data collection server 110a and stores this data with metadata identifying the client, the type of client (e.g. NAICS/SIC code (if any)), the client's location, and any other pertinent identifying information in data aggregation database 132b associated with data aggregation server 132a (203). Next, the risk factor calculating facility associated with data aggregation server 132a retrieves historical loss data associated with the multiplicity of different clients whose normalized operational transaction data, facilities transaction data, and/or security data have been collected (204). Next, the risk factor calculating facility associated with data aggregation server 132a cross-correlates this historical loss data with the aggregated normalized operational transaction data, facilities transaction data, and/or security data collected to create risk weighting factors correlating the captured aggregated standardized data with losses (205). Finally, the risk factor calculating facility associated with data aggregation server 132a stores these risk weighting factors in data aggregation database 132b (206).

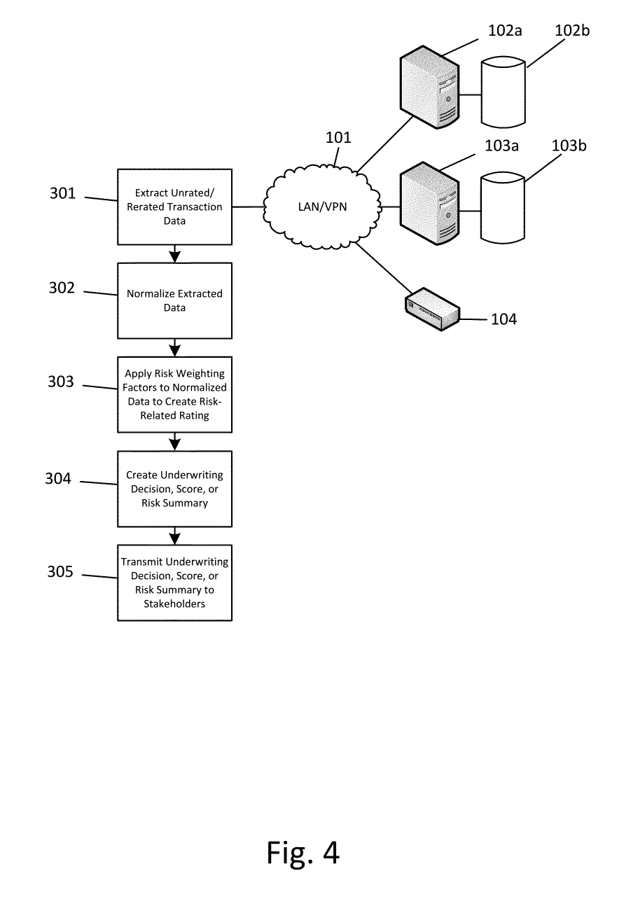

Referring now to FIGS. 1 and 4, a flow diagram showing how one embodiment of the present invention calculates and communicates an underwriting decision, score, or risk/marketing summary to stakeholders in the underwriting process is disclosed. First, data collection server 110a accesses operational transaction data in operations management database 102b by means of operations management server 102a, facilities transaction data in facilities management database 103b by means of facilities management server 103a, and/or security data by means of security system 104 wherein data collection server 110a uses a pre-created, industry-specific data extraction schema to extract the necessary data from the appropriate system(s) installed in the IT infrastructure 100 of either: 1) An unrated entity (an entity that has never been rated for underwriting (e.g. new client)); or, 2) An entity that is to be re-rated (an entity that was previously rated for underwriting (e.g. an existing client)) (301). Next, after collecting operational transaction data, facilities transaction data, and/or security data, data collection server 110a normalizes, or formats, the collected data into a lexically consistent form capable of being consumed by remaining downstream processes (302). Next, at some arbitrary time later (after an arbitrarily sized set of normalized operational transaction data, facilities transaction data, and/or security data has been collected from the unrated/re-rated entity by data collection server 110a), data aggregation server 132a collects the unrated/rerated entity's normalized data from data collection server 110a and correlates this normalized data with risk rating factors previously determined to generate a risk related rating reflecting the observed operational transaction data, facilities transaction data, and/or security data and the historical loss data associated therewith (303). Next, data aggregation server 132a calculates an underwriting decision, score, or risk summary (304). Next, data aggregation server 132a communicates this underwriting decision, score, or risk/marketing summary to stakeholders in the underwriting process (305).

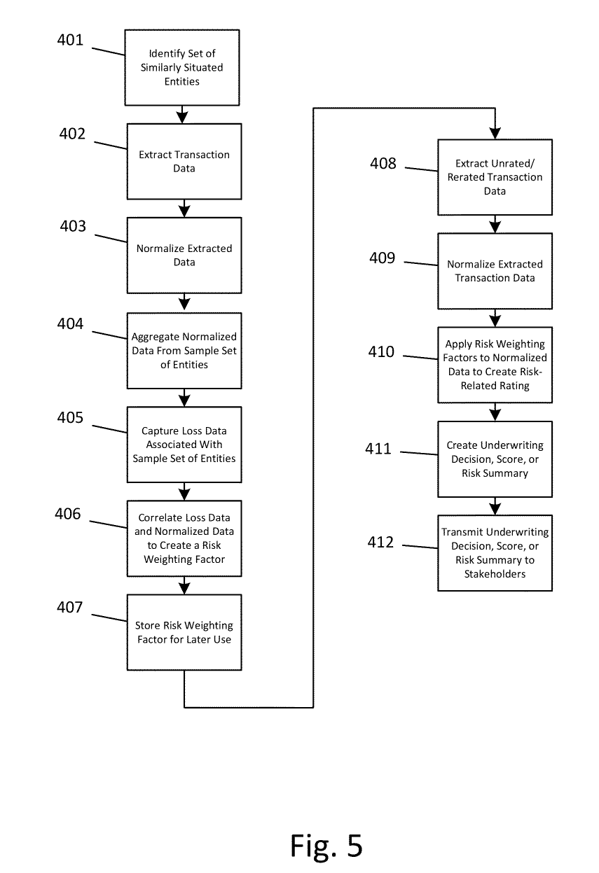

Referring now to FIGS. 1 and 5, a flow diagram illustrating the method whereby an embodiment of the present invention creates risk weighting factors correlating aggregated standardized operations and facility management and/or security system transaction data with losses and subsequently calculates and communicates an underwriting decision, score, or risk/marketing summary to stakeholders in the underwriting process. First, a sample set of similarly situated entities are identified and a data collection server 110a and associated data collection database 110b is installed in the IT infrastructure 100 of each of the respective identified entities. The necessary pre-created data extraction and normalization schema to extract and normalize, respectively, the necessary data from each of the identified entities' operational transaction data, facilities transaction data, and/or security data are created or provided (401). Next, these data collection servers 110a access the operational transaction data, facilities transaction data, and/or security data using the provided pre-created, industry-specific data extraction schema to extract the necessary data from the appropriate system of each respective entity (402). Next, these data collection servers 110a normalize the collected operational transaction data, facilities transaction data, and/or security data system of each respective entity using the provided pre-created, industry-specific data normalizing schema to normalize, or format, the collected data into a lexically consistent form capable of being consumed by remaining downstream processes (403). Next, at some arbitrary time later, data aggregation server 132a collects normalized data from the multiplicity of data collection servers 110a and stores this data with metadata identifying the client, the type of client (e.g. NAICS/SIC code (if any)), the client's location, and any other pertinent identifying information in data aggregation database 132b (404). Next, data aggregation server 132a retrieves historical loss data associated with the multiplicity of different entities whose normalized operational transaction data, facilities transaction data, and/or security data have been collected (405). Next, the risk factor calculating facility associated with data aggregation server 132a cross-correlates this historical loss data with the aggregated normalized operational transaction data, facilities transaction data, and/or security data to create risk weighting factors correlating captured aggregated standardized data with losses (406). Next, the risk factor calculating facility associated with data aggregation server 132a stores these risk weighting factors in data aggregation database 132b (407). Next, at some arbitrary time later, a data collection server 110a equipped with the necessary pre-created, industry-specific data extraction and data normalization schema to extract and normalize, respectively, operational transaction data, facilities transaction data, and/or security data is installed and/or activated to access the operational transaction data, facilities transaction data, and/or security data of an unrated entity, or an entity to be re-rated. Data collection server 110a then collects operational transaction data, facilities transaction data, and/or security data for some arbitrary period of time (408). Next, after collecting operational transaction data, facilities transaction data, and/or security data, data collection server 110a normalizes, or formats, the collected data into a lexically consistent form capable of being consumed by remaining downstream processes (409). Next, at some arbitrary time later (after an arbitrarily sized set of normalized operational transaction data, facilities transaction data, and/or security data has been collected from the unrated/re-rated entity by data collection server 110a), data aggregation server 132a collects the unrated/rerated entity's normalized data from data collection server 110a and correlates this normalized data with risk rating factors previously determined to generate a risk related rating reflecting the observed operational transaction data, facilities transaction data, and/or security data and the historical loss data associated therewith (410). Next, data aggregation server 132a calculates an underwriting decision, score, or risk/marketing summary (411). Next, data aggregation server 132a communicates this underwriting decision, score, or risk/marketing summary to stakeholders in the underwriting process (412).

It will be readily apparent to those having skill in the art that the above embodiments are generically disclosed as all having discreet network connected server/database architectures and that numerous other physical, architecturally distributed or cloud-based embodiments can support the same kinds of data and functionality. For example, data collection server 110a and data collection database 110b may be integrated into one device, such as a rack-mounted appliance or USB dongle. Further, data collection server 110a, data aggregation server 132a and their associated databases may be all rendered on a unitary localized computing platform or remotely, as in the cloud.

By the same token, it will be readily apparent to one having skill in the art that the system disclosed may be readily reorganized into alternate architectures and data flows, including but not limited to: 1) A system/method wherein the data aggregation process occurs prior to data normalization and subsequent dissemination of the normalized data; or, 2) A system/method wherein data collection server 110a collects data of such high uniformity, that the data normalization process is eliminated altogether. Thus, these and all other such readily apparent variants are implicitly included in the spirit and scope of the present disclosure.

1. A system for assessing risk and marketing potential using industry-specific operations management transaction data, comprising:
a. a data collection server and associated data collection database capable of:
i. extracting and normalizing the operational transaction data of at least one sample entity using pre-created, industry-specific data extraction and normalization schema, respectively;
ii. storing the normalized operational transaction data with metadata identifying the at least one sample entity in the data collection database;
b. a data aggregation server and associated data aggregation database wherein the data aggregation server is in communication with at least one data collection server associated with at least one sample entity, and capable of:
i. aggregating the normalized operational transaction data and associated metadata collected from the at least one data collection server associated with at least one sample entity;
ii. retrieving historical loss data associated with the at least one sample entity;
iii. cross-correlating the historical loss data with the aggregated normalized operational transaction data and associated metadata to create a risk-weighting factor associating the observed aggregated normalized operational transaction data and associated metadata with losses; and
iv. storing the risk-weighting factor.

2. A system of claim 1 wherein the data aggregation server and data collection server communicate by means of a network.

3. A system of claim 1 wherein the data aggregation server and data collection server communicate by means of a USB connection.

4. A system of claim 1 wherein the data aggregation server and data collection server exist on the same device.

5. A system of claim 1 further comprising a home monitoring/security system.

6. A system of claim 1 wherein the assessing risk and marketing potential further comprises assisting the underwriting process.

7. A system of claim 1 wherein the assessing risk and marketing potential further comprises assisting the pricing/quoting process.

8. A system of claim 1 wherein the assessing risk and marketing potential further comprises assisting the retention management process.

9. A system of claim 1 wherein the retention management process further comprises benchmarking.

10. A system of claim 1 wherein the retention management process further comprises referral product marketing.

11. A system of claim 1 wherein the risk-weighting factor relates to a decision whether or not to extend credit.

12. A system of claim 1 wherein the risk-weighting factor relates to a decision whether or not to issue an insurance policy.

13. A system of claim 1 wherein the losses are losses occurring from the extension of credit.

14. A system of claim 1 wherein the losses are losses occurring from the issuance of an insurance policy.

15. A method of using the system of claim 1 comprising the steps of:
a. extracting and normalizing the operational transaction data of a multiplicity of sample entities using pre-created, industry-specific data extraction and normalization schema, respectively;
b. storing the normalized operational transaction data with metadata identifying each of the multiplicity of sample entities in at least one data collection database;
c. aggregating the normalized operational transaction data with metadata identifying each of the multiplicity of sample entities collected from the at least one data collection server associated with the multiplicity of sample entities;
d. retrieving historical loss data associated with each of the multiplicity of sample entities;
e. cross-correlating the historical loss data associated with each of the multiplicity of sample entities with the aggregated normalized operational transaction data and associated metadata associated with each of the multiplicity of sample entities to create a risk-weighting factor associating the observed aggregated normalized operational transaction data and associated metadata with losses;
f. storing the risk-weighting factor;
g. subsequently extracting and normalizing the operational transaction data from a target entity using pre-created, industry-specific data extraction and normalization schema, respectively;
h. storing the normalized operational transaction data with metadata identifying the target entity;
i. cross-correlating the normalized operational transaction data with metadata identifying the target entity with the risk-weighting factors created a priori;
j. generating a risk related rating reflective of the normalized operational transaction data with metadata identifying the target entity in view using the risk-weighting factors associated with the historical sample normalized operational transaction data with metadata;
k. calculating an underwriting decision, score, or risk/marketing summary relating to the target entity's request;
l. communicating the underwriting decision, score, or risk/marketing summary relating to the target entity's request to stakeholders in the underwriting process.

16. A method of claim 15 wherein the underwriting decision, score, or risk/marketing summary communicates the desirability of extending credit and the rate at which credit will be extended.

17. A method of claim 15 wherein the underwriting decision, score, or risk/marketing summary communicates the desirability of offering insurance to the target entity and the rate at which a policy will be offered.

18. A method of claim 15 wherein the target entity has not been rated before.

19. A method of claim 15 wherein the target entity is an entity that is to be re-rated.
